(19) United States
(12) Patent Application Publication
(10) Pub. No.: US 2026/0209576 A1
(43) Pub. Date: Jul. 23, 2026

(54) Aqueous Adhesive Composition, Transport Belt, And Ink Jet Textile Printing Apparatus

(71) Applicant: SEIKO EPSON CORPORATION, Tokyo (JP)

(72) Inventors: Koichi TERAO, Suwa (JP); Soichi YAMAZAKI, Shiojiri (JP); Nikako TSUKIJI, Matsumoto (JP); Harunobu KOMATSU, Matsumoto (JP)

(21) Appl. No.: 19/456,475

(22) Filed: Jan. 22, 2026

(30) Foreign Application Priority Data
Jan. 23, 2025 (JP) 2025-009681

(51) Int. Cl. C09J 133/06; B41J 3/407; B41J 15/04; C08K 5/00; D06P 5/30

(52) U.S. Cl. CPC C09J 133/064; B41J 3/4078; B41J 15/048; C08K 5/0058; D06P 5/30

(57) ABSTRACT

An aqueous adhesive composition for forming an adhesive layer on a surface of a transport member of an ink jet textile printing apparatus, which transports a fabric, includes water and a (meth)acrylic resin, in which the (meth)acrylic resin has a glass transition temperature of −40°C to −10°C, and when 5 parts by mass of a dried substance obtained by drying the aqueous adhesive composition and removing the water is immersed in 95 parts by mass of tetrahydrofuran and is allowed to stand at 25°C for 24 hours, a mass of an insoluble component of the (meth)acrylic resin that is not dissolved in the tetrahydrofuran is 1% to 10% by mass with respect to a total amount of the dried substance.

The present application is based on, and claims priority from JP Application Serial Number 2025-009681, filed January 23, 2025, the disclosure of which is hereby incorporated by reference herein in its entirety.

### BACKGROUND

### Technical Field

The present disclosure relates to an aqueous adhesive composition, a transport belt, and an ink jet textile printing apparatus.

### Related Art

An ink jet recording method enables recording of a high-definition image with a relatively simple device, and enables rapid development to be achieved in various fields. Under the above-described circumstances, various research is conducted on textile recording using a fabric as a recording medium. For example, JP-A-54-030989 discloses an adhesive for screen textile printing containing (1) a diorganopolysiloxane that contains a hydroxyl group of a terminal Si atom bond (here, the organic group is an unsubstituted or substituted monovalent hydrocarbon group), (2) a xylene-soluble copolymer resin that is mainly formed of a triorganosiloxane unit and a SiO₂ unit and contains a hydroxyl group of a Si atom bond (here, the organic group is an unsubstituted or substituted monovalent hydrocarbon group), and (3) a condensation catalyst.

Meanwhile, in an ink jet type textile printing apparatus, a fabric is attached to a transport belt such as an endless belt, and the fabric is transported to a printing section. An adhesive layer is formed at the surface of the transport belt. The fabric is peeled off from the transport belt after printing and is transported to the next step. On the other hand, since the fabric is attached to the transport belt again after being peeled off, it is necessary to remove the ink, the lint, and other remaining members adhering to the transport belt in the printing step. The remaining members such as the ink and the lint adhering to the transport belt are typically washed with water. When the remaining members are washed, a brush, a sponge, or the like may be used to clean the transport belt.

An adhesive layer used for such ink jet textile printing is required to have an adhesive force that can stably attach and detach the fabric and high water resistance and mechanical strength that can withstand washing with water, and thus, an adhesive composition in which a hydrophobic resin is dissolved in an organic solvent is usually used as the material of the adhesive layer.

When such an adhesive composition containing an organic solvent is used, the organic solvent is volatilized during application of the adhesive composition, and thus it is necessary to consider the work environment or to provide an exhaust facility so that an operator does not inhale the volatilized organic solvent. Therefore, there is a demand for an aqueous adhesive composition for improving the work environment and reducing the environmental load.

### SUMMARY

According to an aspect of the present disclosure, there is provided an aqueous adhesive composition for forming an adhesive layer on a surface of a transport member of an ink jet textile printing apparatus, which transports a fabric, the aqueous adhesive composition including: water; and a (meth)acrylic resin, in which the (meth)acrylic resin has a glass transition temperature of −40°C to −10°C, and when 5 parts by mass of a dried substance obtained by drying the aqueous adhesive composition and removing the water is immersed in 95 parts by mass of tetrahydrofuran and stands at 25°C for 24 hours, a mass of an insoluble component of the (meth)acrylic resin that is not dissolved in the tetrahydrofuran is 1% to 10% by mass with respect to a total amount of the dried substance.

According to another aspect of the present disclosure, there is provided a transport belt of an ink jet textile printing apparatus, which transports a fabric, the transport belt including: an adhesive layer containing the aqueous adhesive composition on a surface of the transport belt, which is in contact with the fabric.

According to still another aspect of the present disclosure, there is provided an ink jet textile printing apparatus including: the transport belt; and an ink jet head having a nozzle that ejects an ink to the fabric transported by the transport belt.

### BRIEF DESCRIPTION OF THE DRAWINGS

FIG. 1 is a schematic view showing a recording apparatus that is used in the present embodiment.

FIG. 2 is a table showing examples and comparative examples.

### DESCRIPTION OF EMBODIMENTS

Hereinafter, an embodiment of the present disclosure (hereinafter, referred to as “the present embodiment”) will be described in detail with reference to the accompanying drawings, but the present disclosure is not limited thereto, and various modifications can be made within a range not departing from the scope of the present disclosure. In the drawings, the same elements are denoted by the same reference numerals and the repetitive description will be omitted. Further, the positional relationships, such as the left, the right, the top, and the bottom, are based on the positional relationships shown in the drawings unless otherwise specified. In addition, the dimensional ratios in the drawings are not limited to ratios shown in the drawings.

The term “(meth)acrylate” is a generic expression of an acrylate and a methacrylate. Further, the term “unit” such as “constitutional unit” or “(meth)acrylate unit” denotes a repeating unit derived from a monomer when the monomer is polymerized into a polymer.

### Aqueous adhesive composition

An aqueous adhesive composition according to the present embodiment (hereinafter, also simply referred to as “aqueous adhesive composition”) is an aqueous adhesive composition for forming an adhesive layer on a surface of a transport member of an ink jet textile printing apparatus, which transports a fabric, the aqueous adhesive composition including water and a (meth)acrylic resin, in which the (meth)acrylic resin has a glass transition temperature of −40°C to −10°C, and when 5 parts by mass of a dried substance obtained by drying the aqueous adhesive composition and removing the water is immersed in 95 parts by mass of tetrahydrofuran and is allowed to stand at 25°C for 24 hours, a mass of an insoluble component of the (meth)acrylic resin that is not dissolved in the tetrahydrofuran is 1% to 10% by mass with respect to the total amount of the dried substance.

The aqueous adhesive used for the adhesive layer provided on the surface of the transport belt of the ink jet textile printing apparatus, which transports a fabric, has room for improvement in terms of the adhesiveness and the peelability from the fabric.

In this regard, since the (meth)acrylic resin contained in the aqueous adhesive composition of the present embodiment has a glass transition temperature of -40°C or higher, the aqueous adhesive composition tends to have moderate hardness. In this manner, when the fabric is peeled off from the adhesive layer formed at the surface of the transport member of the ink jet textile printing apparatus, which transports the fabric, the fabric is easily peeled off, that is, the peelability of the fabric is improved, and the mechanical strength of the adhesive layer tends to be improved. In addition, the adhesiveness of the adhesive layer does not deteriorate even when used for a long time, that is, the durability of the adhesive layer tends to be improved.

In addition, since the (meth)acrylic resin has a glass transition temperature of −10°C or lower, the aqueous adhesive composition tends to have moderate softness. In this manner, the adhesive layer is likely to adhere closely to the fabric, that is, the adhesiveness of the fabric is improved.

The glass transition temperature of the (meth)acrylic resin is preferably -35 to -10°C, more preferably -30 to -12°C, and still more preferably -25 to -15°C. As a result, the peelability of the fabric is further improved, the mechanical strength of the adhesive layer is further improved, the durability of the adhesive layer is further improved, and the adhesiveness of the fabric is further improved.

The glass transition temperature (Tg) of the (meth)acrylic resin can be adjusted, for example, by adjusting the type of monomer constituting the (meth)acrylic resin. Specifically, the (meth)acrylic resin has constitutional units derived from a monomer having a large molecular weight, a monomer having a double bond or a triple bond, a monomer having a large side chain such as an aromatic ring, a monomer containing a terminal group that is a functional group having polarity, and the like, and thus the movement of the polymer chain is restricted, and the Tg tends to be increased.

The glass transition temperature of the (meth)acrylic resin can be measured by a method known in the related art using differential scanning calorimetry (DSC).

When 5 parts by mass of the dried substance obtained by drying the aqueous adhesive composition and removing water is immersed in 95 parts by mass of tetrahydrofuran and is allowed to stand at 25°C for 24 hours, the mass of an insoluble component of the (meth)acrylic resin that is not dissolved in the tetrahydrofuran is 1% by mass or greater with respect to the total amount of the dried substance, since the aqueous adhesive composition has moderate hardness, the peelability of the fabric is improved, and the mechanical strength of the adhesive layer tends to be improved. In addition, the durability of the adhesive layer tends to be improved.

In addition, since the mass of the insoluble component of the (meth)acrylic resin is 10% by mass or less with respect to the total amount of the dried substance, the aqueous adhesive composition has moderate softness, and thus the adhesiveness of the fabric tends to be improved.

The mass of the insoluble component of the (meth)acrylic resin is preferably 1.5% to 9.5% by mass, more preferably 2.0% to 9.0% by mass, still more preferably 2.5% to 8.5% by mass, and even still more preferably 3.0% to 8.0% by mass. As a result, the peelability of the fabric is further improved, the mechanical strength of the adhesive layer is further improved, the durability of the adhesive layer is further improved, and the adhesiveness of the fabric is further improved.

The mass of the insoluble component of the (meth)acrylic resin can be adjusted, for example, by adjusting the type of monomer constituting the (meth)acrylic resin. Specifically, when the (meth)acrylic resin has a constitutional unit derived from a polyfunctional (meth)acrylate, the polymer chains in the (meth)acrylic resin have a network structure or a three-dimensional structure, and the mass of the insoluble component tends to increase, that is, the gel fraction tends to increase. Alternatively, the gel fraction tends to increase by using a crosslinking agent. Alternatively, the gel fraction tends to increase by carrying out a reaction at a high temperature or a reaction for a long period of time.

The mass of the insoluble component of the (meth)acrylic resin can be measured, for example, by the following method. That is, 5 parts by mass of the dried substance obtained by drying the aqueous adhesive composition to remove water is immersed in 95 parts by mass of tetrahydrofuran (THF) and allowed to stand at room temperature (25°C) for 24 hours, and the supernatant (soluble component) and the precipitate (insoluble component) are separated using a centrifugal separator. Further, the precipitate is dried, the dry mass of the precipitate is measured, and the gel fraction is calculated according to the following formula.

Formula: (dry mass of precipitate)/(mass of dried substance) × 100

A method of drying the aqueous adhesive composition is not particularly limited, but a drying method in which the aqueous adhesive composition is not exposed to a high temperature is preferable. Examples thereof include a method of allowing the aqueous adhesive composition to stand in an environment at room temperature to naturally dry the aqueous adhesive composition, a method of blowing air at room temperature to the aqueous adhesive composition to dry the aqueous adhesive composition, and a method of freeze-drying the aqueous adhesive composition.

In addition, the molecular weight of the soluble component described below is easily measured by using tetrahydrofuran as a solvent that dissolves the dried substance in the measurement of the mass of the insoluble component.

Hereinafter, each of the components in the aqueous adhesive composition will be described in detail.

### 1.1. MethAcrylic Resin

The (meth)acrylic resin of the present embodiment may be a water-soluble resin or resin particles dispersed in an aqueous solvent. These will also be generically referred to as the (meth)acrylic resin in the present embodiment. Further, the resin particles dispersed in an aqueous solvent will also be referred to as a resin emulsion.

When 5 parts by mass of the (meth)acrylic resin of the present embodiment and 95 parts by mass of tetrahydrofuran are mixed and allowed to stand at 25°C for 24 hours, the weight-average molecular weight of the soluble component of the (meth)acrylic resin dissolved in the tetrahydrofuran is preferably 50 × 10⁴ to 200 × 10⁴ Da, more preferably 70 × 10⁴ to 175 × 10⁴ Da, and still more preferably 90 × 10⁴ to 150 × 10⁴ Da. When the weight-average molecular weight thereof is 50 × 10⁴ Da or greater, the mechanical strength of the adhesive layer tends to be further improved. Further, when the weight-average molecular weight thereof is 200 × 10⁴ Da or less, the adhesiveness of the fabric tends to be further improved.

The weight-average molecular weight of the soluble component can be adjusted, for example, by adjusting the type of monomer constituting the (meth)acrylic resin. Specifically, the weight-average molecular weight of the soluble component tends to increase by using a monomer having a large molecular weight. Alternatively, the weight-average molecular weight of the soluble component tends to increase when the (meth)acrylic resin has a constitutional unit derived from a polyfunctional (meth)acrylate. Alternatively, the weight-average molecular weight of the soluble component can be adjusted by adjusting the reaction temperature.

The content of the (meth)acrylic resin is preferably 20% to 80% by mass, more preferably 30% to 60% by mass, and still more preferably 40% to 60% by mass with respect to the total amount of the aqueous adhesive composition. When the content of the (meth)acrylic resin is in the above-described ranges, the peelability of the fabric is further improved, the mechanical strength of the adhesive layer is further improved, and the adhesiveness of the fabric is further improved.

The (meth)acrylic resin of the present embodiment is obtained by polymerizing a (meth)acrylate as a monomer, and has a constitutional unit derived from a (meth)acrylate. In addition, the (meth)acrylic resin of the present embodiment may be obtained by copolymerizing, in addition to a (meth)acrylate, an allyl monomer such as an allyl alcohol, a vinyl monomer such as styrene, and monomers other than the (meth)acrylate, such as (meth)acrylic acid.

Examples of the (meth)acrylate include a monofunctional (meth)acrylate and a polyfunctional (meth)acrylate.

### 1.1.1. Monofunctional methacrylate

The (meth)acrylic resin has a constitutional unit derived from a monofunctional (meth)acrylate, and thus the adhesiveness of the fabric tends to be further improved.

The monofunctional (meth)acrylate is not particularly limited, and examples thereof include aromatic group-containing monofunctional (meth)acrylates such as phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate, alicyclic group-containing monofunctional (meth)acrylates such as isobornyl (meth)acrylate (IBXA), tert-butylcyclohexanol acrylate (TBCHA), and 2-(meth)acrylic acid-1,4-dioxaspiro[4,5]dec-2-ylmethyl, linear or branched aliphatic group-containing monofunctional (meth)acrylates such as methyl (meth)acrylate, ethyl (meth)acrylate, butyl (meth)acrylate, isoamyl (meth)acrylate, cyclohexyl (meth)acrylate, 2-ethylhexyl (meth)acrylate, stearyl (meth)acrylate, lauryl (meth)acrylate, octyl (meth)acrylate, decyl (meth)acrylate, isodecyl (meth)acrylate, isomyristyl (meth)acrylate, isostearyl (meth)acrylate, 2-hydroxybutyl (meth)acrylate, butoxyethyl (meth)acrylate, tetrahydrofurfuryl (meth)acrylate, 2-hydroxyethyl (meth)acrylate, and 2-hydroxypropyl (meth)acrylate, and lactone-modified flexible (meth)acrylate. The monofunctional (meth)acrylate may be used alone or in combination of two or more kinds thereof.

The content of the monofunctional (meth)acrylate is preferably 80.0% by mass or greater and less than 100.0% by mass, more preferably 90.0% by mass or greater and 99.9% by mass or less, still more preferably 95.0% by mass or greater and 99.9% by mass or less, even still more preferably 97.0% by mass or greater and 99.9% by mass or less, and particularly preferably 99.0% by mass or greater and 99.9% by mass or less with respect to the total amount of (meth)acrylic resin. In this manner, the adhesion of the fabric tends to be further improved.

### 1.1.2. Polyfunctional methacrylate

Since the (meth)acrylic resin has a constitutional unit derived from a polyfunctional (meth)acrylate, the resin is likely to have a network structure or a three-dimensional structure. As a result, when the resin has moderate hardness, the peelability of the fabric is further improved, and the mechanical strength of the adhesive layer tends to be further improved.

The polyfunctional (meth)acrylate is not particularly limited, and examples thereof include bifunctional (meth)acrylates such as 1,6-hexanediol di(meth)acrylate, 3-methyl-1,5-pentanediol di(meth)acrylate, 1,3-propanediol di(meth)acrylate, 1,10-decanediol di(meth)acrylate, tetraethylene glycol di(meth)acrylate, tripropylene glycol di(meth)acrylate, neopentyl glycol di(meth)acrylate, 1,4-butanediol di(meth)acrylate, diethylene glycol di(meth)acrylate, 1,3-butanediol di(meth)acrylate, 1,9-nonanediol di(meth)acrylate, 4,4'-biphenol di(meth)acrylate, ethylene glycol di(meth)acrylate, and triethylene glycol di(meth)acrylate, and trifunctional or higher polyfunctional (meth)acrylates such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, tri(meth)acrylic acid glycerin, glycerin propoxy tri(meth)acrylate, caprolactone-modified trimethylolpropane tri(meth)acrylate, pentaerythritol ethoxytetra(meth)acrylate, and caprolactam-modified dipentaerythritol hexa(meth)acrylate. The polyfunctional (meth)acrylate may be used alone or in combination of two or more kinds thereof.

The content of the constitutional unit derived from a polyfunctional (meth)acrylate is preferably greater than 0% by mass and 2% by mass or less, more preferably greater than 0% by mass and 1% by mass or less, still more preferably 0.1% by mass or greater and 0.9% by mass or less, even still more preferably 0.2% by mass or greater and 0.8% by mass or less, and even still more preferably 0.3% by mass or greater and 0.7% by mass or less with respect to the total amount of the (meth)acrylic resin. In this manner, the peelability of the fabric is further improved, and the mechanical strength of the adhesive layer tends to be further improved.

### 1.2. Preservative

It is preferable that the aqueous adhesive composition of the present embodiment contains a preservative. In this manner, bacteria and mold are difficult to generate in the adhesive layer containing the aqueous adhesive composition, that is, the preservative property of the adhesive layer tends to be improved.

Examples of the preservative include organic preservatives and inorganic preservatives. The organic preservatives are not particularly limited, and examples thereof include a thiazoline-based antibacterial agent, an imidazole-based antibacterial agent, an ester-based antibacterial agent, and a carboxylic acid-based antibacterial agent. The preservative may be used alone or in combination of two or more kinds thereof.

The thiazoline-based antibacterial agent is not particularly limited, and examples thereof include 2-n-octyl-4-isothiazolin-3-one, 1,2-benzisothiazol-3(2H)-one, methylisothiazolinone, and 5-chloro-2-methyl-4-isothiazolin-3-one.

The imidazole-based antibacterial agent is not particularly limited, and examples thereof include 2-(4-thiazolyl)-benzimidazole and methyl-2-benzimidazole carbamate.

The ester-based antibacterial agent is not particularly limited, and examples thereof include lauric acid monoglyceride.

The carboxylic acid-based antibacterial agent is not particularly limited, and examples thereof include sorbic acid and a salt thereof. Examples of such a salt include a potassium salt.

The inorganic preservatives are not particularly limited, and examples thereof include a silver compound such as silver nitrate, a copper compound such as copper sulfate, a zinc compound such as zinc oxide, and a boron compound such as boric acid.

The content of the preservative is preferably 0.001% to 0.100% by mass, more preferably 0.002% to 0.090% by mass, and still more preferably 0.003% to 0.080% by mass with respect to the total amount of the (meth)acrylic resin. When the content of the preservative is 0.001% by mass or greater, the preservative property of the adhesive layer tends to be further improved. In addition, when the content of the preservative is 0.100% by mass or less, the adhesiveness of the fabric tends to be further improved, and the mechanical strength of the adhesive layer tends to be further improved. In addition, from the viewpoint of safety, the content of the preservative is preferably 0.100% by mass or less.

The content of the preservative is preferably 0.001% to 0.100% by mass, more preferably 0.002% to 0.075% by mass, and still more preferably 0.002% to 0.050% by mass with respect to the total amount of the aqueous adhesive composition. When the content of the preservative is 0.001% by mass or greater, the preservative property of the adhesive layer tends to be further improved. In addition, when the content of the preservative is 0.100% by mass or less, the adhesiveness of the fabric tends to be further improved, and the mechanical strength of the adhesive layer tends to be further improved.

### 1.3. Surfactant

The aqueous adhesive composition of the present embodiment may contain a surfactant. The surfactant is not particularly limited, and examples thereof include an anionic surfactant, a nonionic surfactant, and a cationic surfactant. The surfactant may be used alone or in combination of two or more kinds thereof.

Examples of the anionic surfactant include ammonium polyoxyalkylene alkyl ether sulfate, an alkyl sulfocarboxylate, an alkyl diphenyl ether disulfonate, an α-olefin sulfonate, a polyoxyethylene alkyl ether acetate, N-acylamino acid and a salt thereof, an N-acylmethyl taurine salt, an alkyl sulfate such as ammonium lauryl sulfate or sodium lauryl sulfate, a polyoxyalkyl ether sulfate, a polyoxyethylene alkyl ether phosphate, rosin acid soap, castor oil sulfate, lauryl alcohol sulfate, alkylphenol type phosphate, alkyl type phosphate, an alkylaryl sulfonate, a diethyl sulfosuccinate, a diethyl hexyl sulfosuccinate, and a dioctyl sulfosuccinate.

Examples of the nonionic surfactant include an acetylene glycol-based surfactant, a silicone-based surfactant, polyoxyethylene alkyl ether, polyoxyethylene alkyl phenyl ether, polyoxyethylene fatty acid ester, polyoxyethylene hardened castor oil, propylene glycol fatty acid ester, glycerin fatty acid ester, polyglycerin fatty acid ester, sorbitan fatty acid ester, sucrose fatty acid ester, alkyl polyglycoside, alkyl diethanolamide, and alkyl amine oxide.

Examples of the cationic surfactant include alkylamine salts, fatty acid amidoamine salts, monoalkyl quaternary ammonium salts, dialkyl quaternary ammonium salts, trialkyl quaternary ammonium salts, benzalkonium quaternary ammonium salts, benzetonium chloride, and alkylpyridinium salts.

The content of the surfactant is not particularly limited, but is, for example, 1.0% to 5.0% by mass with respect to the total amount of the (meth)acrylic resin. In addition, the content of the surfactant is not particularly limited, but is, for example, 0.5% to 2.5% by mass with respect to the total amount of the aqueous adhesive composition.

### 1.4. pH adjuster

The aqueous adhesive composition of the present embodiment may contain a pH adjuster. The pH adjuster is not particularly limited, but examples thereof include an inorganic acid (for example, sulfuric acid, hydrochloric acid, or nitric acid), an inorganic base (for example, lithium hydroxide, sodium hydroxide, potassium hydroxide, ammonia, or an ammonium salt), an organic base (triethanolamine, diethanolamine, monoethanolamine, or tripropanolamine), and an organic acid (for example, adipic acid, citric acid, or succinic acid). The pH adjuster may be used alone or in combination of two or more kinds thereof.

Among these, ammonia or an ammonium salt is preferable. Ammonia is volatilized during formation of the adhesive layer and the (meth)acrylic resins are likely to adhere to each other, by using such a pH adjuster, and thus a coating film into which water is difficult to enter is formed. Therefore, the durability of the adhesive force and the water resistance of the adhesive layer tend to be improved, and the adhesiveness tends to be maintained in a wide temperature range.

The content of the pH adjuster is not particularly limited, but is, for example, 0.05% to 1.50% by mass with respect to the total amount of the aqueous adhesive composition. The aqueous adhesive composition may contain the pH adjuster such that the pH of the aqueous adhesive composition is 8.0 to 9.0. In this manner, the durability of the adhesive force and the water resistance are improved, and the adhesiveness tends to be maintained in a wide temperature range.

### 1.5. Water

The content of the water is preferably 30% to 80% by mass, more preferably 35% to 70% by mass, and still more preferably 40% to 60% by mass with respect to the total amount of the aqueous adhesive composition.

### 1.6. Organic solvent

From the viewpoint of reducing the environmental load or the influence on a human body, it is preferable that the aqueous adhesive composition according to the present embodiment contains no organic solvent. In addition, when the aqueous adhesive composition contains an organic solvent, the content of the organic solvent is preferably 5.0% by mass or less, more preferably 2.5% by mass or less, and still more preferably 1.0% by mass or less with respect to the total amount of the aqueous adhesive composition. In this manner, the environmental load can be reduced, the amount of volatile organic compounds (VOC) during the use of the aqueous adhesive composition can be reduced, and thus the work environment tends to be further improved.

### 1.7. Other additives

The aqueous adhesive composition of the present embodiment may include additives other than each of the components described above. The other additives are not particularly limited, and examples thereof include a surfactant, a pH adjuster, and a coloring material. The content of the other additives is not particularly limited, but is, for example, 0.1% to 5.0% by mass with respect to the total amount of the aqueous adhesive composition.

### 2. Method of producing aqueous adhesive composition

The aqueous adhesive composition of the present embodiment is not particularly limited, and is obtained, for example, by dissolving or dispersing a resin obtained by polymerizing the above-described monomer and, as necessary, other components in water. Alternatively, the aqueous adhesive composition is obtained by dissolving or dispersing a resin prepared in advance and, as necessary, other components in water.

The polymerization method is not particularly limited, but for example, the monomer and the surfactant may be mixed and stirred in water, and a polymerization initiator such as ammonium persulfate may be added to the obtained mixed liquid to polymerize the monomer. During the polymerization reaction, the mixed liquid may be heated to a temperature range of 50°C to 90°C. After the polymerization reaction is completed, the mixed liquid may be cooled, and water and a pH adjuster may be added to the mixed liquid during cooling. In this manner, a resin emulsion is obtained.

The obtained resin emulsion may be used as the aqueous adhesive composition, or the aqueous adhesive composition may be obtained by adding a preservative or the like to the resin emulsion.

### 3. Ink jet textile printing apparatus

The ink jet textile printing apparatus of the present embodiment includes a transport belt that transports a fabric and includes an adhesive layer containing the aqueous adhesive composition on a surface that is in contact with the fabric, and an ink jet head having a nozzle that ejects an ink to the fabric to be transported by the transport belt. In addition, the ink jet textile printing apparatus of the present embodiment may include a washing section that washes the adhesive layer after recording is carried out using the ink jet head and the fabric is peeled off from the adhesive layer.

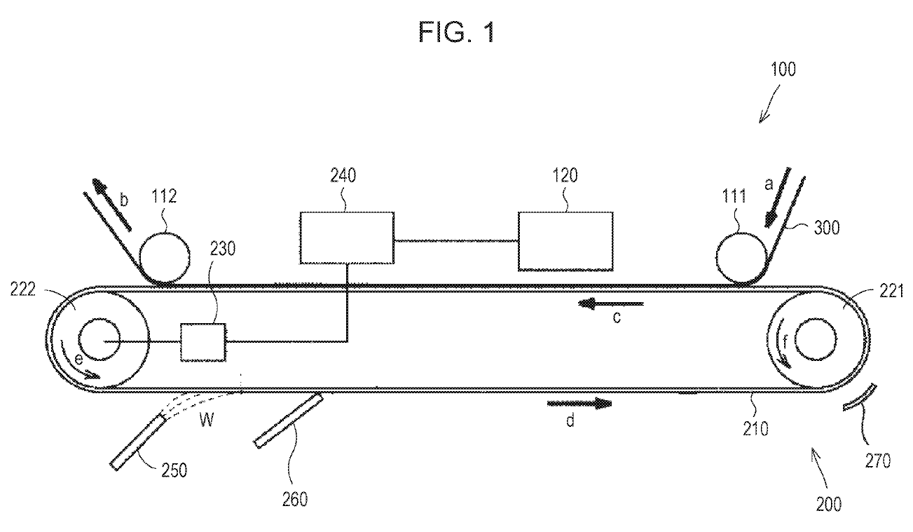

An ink jet textile printing apparatus 100 according to the present embodiment will be described with reference to FIG. 1. FIG. 1 is a configuration view showing the entire ink jet textile printing apparatus 100 including a transport device 200 according to the present embodiment. In FIG. 1, arrows a and b indicate a transport direction of a fabric 300 which is a recording medium. Arrows c and d indicate a rotation direction of a transport belt 210. Arrows e and f indicate a rotation direction of transport rollers 221 and 222.

The ink jet textile printing apparatus 100 may include a transport device 200 for attaching and transporting the fabric on the surface, fabric transport rollers 111 and 112, and a recording section 120. The fabric 300 coming from the direction a is pressed against the transport belt 210 by the fabric transport roller 111, and the fabric 300 is bonded to the surface of the transport belt 210.

The fabric 300 is transported to directly below the recording section 120 by the transport device 200 in a state where the fabric 300 is bonded to the surface of the transport belt 210, and the recording section 120 performs recording on the fabric 300. Thereafter, the transport belt 210 and the fabric 300 are peeled off from each other by the fabric transport roller 112.

The recording section 120 may be an ink jet head having a nozzle that ejects an ink to the fabric. In the present embodiment, the recording section 120 is assumed to use an ink jet type head to perform textile printing on the fabric 300, but the present disclosure is not limited thereto. For example, recording may be performed by analog textile printing such as hand textile printing or rotary textile printing. The transport belt including the adhesive layer that contains the above-described aqueous adhesive composition can also be suitably used in analog textile printing.

The transport device 200 may include a pair of transport rollers 221 and 222, the transport belt 210, a drive motor 230, a control device 240, a washing section 250, a removal member 260, and a heater 270.

The transport rollers 221 and 222 are rollers for transporting the transport belt 210 in a certain direction. Further, the transport belt 210 may include a transport member that transports a fabric and an adhesive layer containing the aqueous adhesive composition, which is provided on the transport member, and is provided around the transport rollers 221 and 222. The transport belt 210 transports the fabric in the direction indicated by the arrow c by rotating the transport rollers 221 and 222 using the drive motor 230. The transport belt 210 includes an adhesive layer on a surface that comes into contact with the fabric.

When the adhesive layer containing the above-described aqueous adhesive composition is formed at the transport belt, the fabric tends to be stably fixed during printing and suitably peeled off after printing. In addition, since the adhesive layer has excellent mechanical strength, the adhesive performance tends to be maintained for a long period of time. Further, since the adhesive layer can be formed mainly by using water as a solvent, it is not necessary to consider the work environment so that a worker does not inhale the volatilized organic solvent during the use of the adhesive layer and the load on the environment.

The adhesive layer may be formed by coating the surface of the transport member with the above-described aqueous adhesive composition and drying the aqueous adhesive composition. The coating method is not particularly limited, and examples thereof include blade coating, roll coating, spray coating, dip coating, and a method of manually applying by the aqueous adhesive composition using a brush or a roller. The drying temperature is not particularly limited, but is, for example, 10°C to 60°C. In addition, the drying time is not particularly limited, but is, for example, 1 to 24 hours. The thickness of the adhesive layer is preferably 10 to 200 μm, more preferably 30 to 150 μm, and still more preferably 30 to 100 μm.

As the transport member, an elastic material such as a resin is preferable, and examples of such a material include a urethane resin. A heater (not shown) that heats the transport belt 210 may be installed in the ink jet textile printing apparatus 100. Further, in the step of washing the transport belt 210, a water receiving section (not shown) that receives washing water, a brush (not shown) that cleans the transport belt 210, a sponge (not shown), and the like may be used.

The control device 240 may control any one or both of the transport device 200 and the ink jet textile printing apparatus 100.

The washing section 250 washes the surface of the transport belt 210 from which the fabric 300 is peeled off. The components of the fabric 300 adhering to the transport belt 210 during printing and a colorant for printing are washed by the washing section 250. The washing section 250 may include a pump (not shown), a water spray port, and a water spray pipe.

The removal member 260 removes water adhering to the transport belt 210 by the washing section 250. The removal member 260 is not particularly limited, and examples thereof include a blade. As a material of the blade, an elastic material is preferable. Further, from the viewpoint of wear resistance, polyurethane is preferable. The contact portion with the transport belt 210 may have a rectangular cross section, or may have a shape in which the tip is obliquely cut off.

The heater 270 may be provided downstream of the washing section 250 and upstream of the fabric transport roller 111 that performs a bonding step. When the adhesive layer is heated with the heater 270, the (meth)acrylic resin constituting the adhesive layer is softened, and the adhesive force tends to be further improved.

Examples of the fabric 300 include fabrics made of natural fibers such as silk, cotton, and wool or synthetic fibers such as rayon, nylon and polyester. In addition, the fabric may be a woven fabric, a knitted fabric, a nonwoven fabric, or the like.

### 4. Ink jet textile printing method

An ink jet textile printing method of the present embodiment includes a transport step of transporting a fabric by bonding the fabric to an adhesive layer containing the aqueous adhesive composition formed at a surface of a transport belt of an ink jet textile printing apparatus, a recording step of performing textile recording on the fabric attached to the adhesive layer by using an ink jet head, and a washing step of washing the adhesive layer from which the fabric is peeled off after the textile recording.

### 4.1. Transport step

The transport step is a step of transporting a fabric by bonding the fabric to the adhesive layer containing the aqueous adhesive composition, which is formed at the surface of the transport belt of the ink jet textile printing apparatus. The bonding method is not particularly limited, and examples thereof include a bonding method of pressing both the fabric and the adhesive layer using transport rolls as shown in FIG. 1.

### 4.2. Recording step

The recording step is a step of performing textile recording on the fabric attached to the adhesive layer using an ink jet head. In the recording step, the fabric is transported in a state where the transport belt and the fabric closely adhere to each other via the adhesive layer on the surface of the transport belt, and the ink adheres to the fabric by being ejected from the recording section 120 in the process of transport of the fabric. Next, the fabric to which the ink has adhered may be peeled off from the adhesive layer and recovered.

### 4.3. Washing step

The washing step is a step of washing the adhesive layer from which the fabric is peeled off after the textile recording. Dust such as lint derived from the fabric having adhered to the adhesive layer in the recording step can be removed from the surface of the adhesive layer by the washing step.

### EXAMPLES

Hereinafter, the present disclosure will be described in more detail with reference to examples and comparative examples. The present disclosure is not limited to the following examples. In addition, each operation in the examples was performed in an environment of room temperature (25°C) and 1 atm unless otherwise specified.

### 1. Production of aqueous adhesive composition

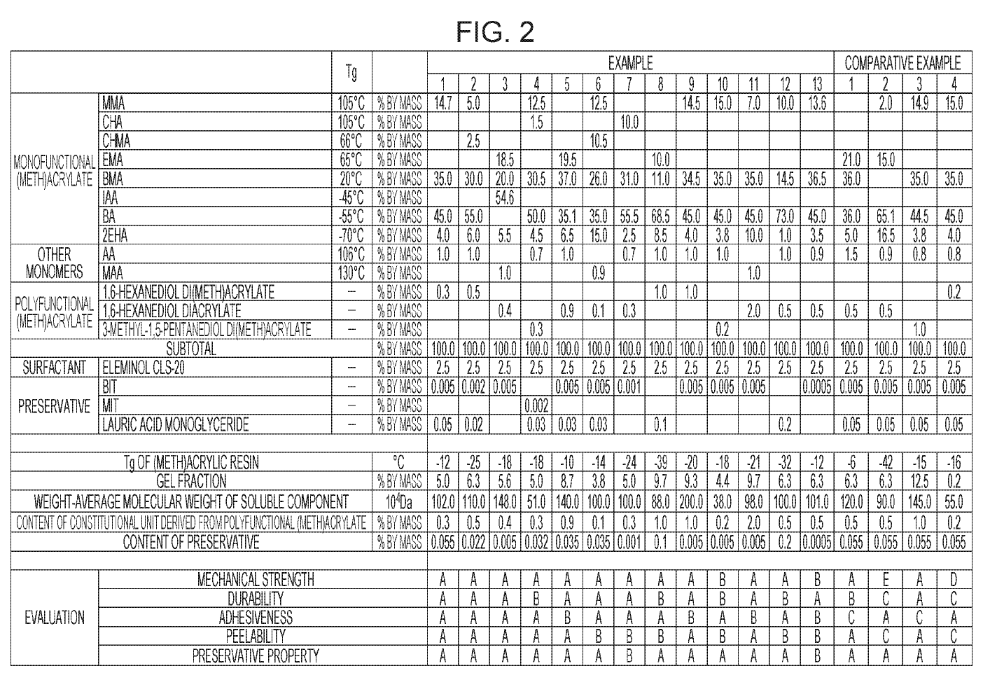

230 g of ion exchange water was added to a reactor provided with a stirrer, a reflux cooling tube, a thermometer, a nitrogen introduction tube, and a dropping funnel, and was heated to 82°C. Thereafter, a total of 1000 g of monomers weight to have the compositional ratio listed in FIG. 2 , 245g of ion exchange water, and 25 g of ELEMINOL CLS-20 (manufactured by SANYO CHEMICAL INDUSTRIES, Ltd., ammonium polyoxyalkylene alkyl ether sulfate, anionic surfactant) were added, mixed, and stirred. 500 g of a 2 mass% aqueous solution of ammonium persulfate serving as a polymerization initiator was added to the uniform solution at 82°C over 1.5 hours.

The solution to which all the above-described types of substances had been added was maintained warm for 2 hours and cooled, and ion exchange water and ammonia water serving as a pH adjuster were added thereto to adjust the pH to 8 or greater and 9 or less. Thereafter, the crude particles were removed by filtering through a 150-mesh nylon filter, thereby obtaining 2000 g of a resin emulsion containing a (meth)acrylic resin having the composition of each example shown in FIG. 2 (solid content of 50% by mass). The amount of each monomer used in FIG. 2 is in units of % by mass with respect to the total amount of monomers. In addition, the glass transition temperature of each monomer shown in FIG. 2 denotes the glass transition temperature of the homopolymer of the monomer. The glass transition temperature of the homopolymer can be obtained from the safety data sheet (SDS) or catalog information of the monomer.

Each of the monomers regarding the constitutional units of the (meth)acrylic resins shown in FIG. 2 is as follows.

MMA: methyl methacrylate

CHA: cyclohexyl acrylate

CHMA: cyclohexyl methacrylate

EMA: ethyl methacrylate

BMA: butyl methacrylate

IAA: isoamyl acrylate

BA: butyl acrylate

2EHA: 2-ethylhexyl acrylate

AA: acrylic acid

MAA: methacrylic acid

Next, the preservative weighed to have the compositional ratio shown in FIG. 2 was added to ion exchange water and stirred and mixed at room temperature, thereby preparing 100 g of an aqueous dispersion containing the preservative. Next, 2000 g of the resin emulsion containing a (meth)acrylic resin and 100 g of the aqueous dispersion containing a preservative were mixed to prepare an aqueous adhesive composition (solid content of 48% by mass) of each example. The amount of the preservative used in FIG. 2 is in units of % by mass with respect to the total amount of the monomers.

The preservatives shown in FIG. 2 are as follows.

BIT: 1,2-benzisothiazol-3(2H)-one, hydrophobic

MIT: methylisothiazolinone, hydrophobic

Lauric acid monoglyceride: water dispersible

### 2. Measurement of physical properties

2.1. Glass transition temperature

The glass transition temperature Tg was measured in conformity with JIS K 7121, and the value obtained by the measurement using a differential scanning calorimeter “DSC8000” (manufactured by PerkinElmer, Inc.) was listed in the columns of “Tg of (meth)acrylic resin” in FIG. 2.

2.2. Gel fraction (mass of insoluble component)

The gel fraction shown in FIG. 2 was measured as follows. That is, first, the aqueous adhesive composition of each example was dried by a freeze-drying method to obtain a dried product. 95 parts by mass of tetrahydrofuran was added to 5 parts by mass of the obtained dried product, and the mixture was allowed to stand for 24 hours. The suspension in which the dry product obtained as described above was swollen and dissolved by tetrahydrofuran was gradually added to 20 times the amount of water to precipitate the resin component and remove the surfactant. The precipitated solid was dried again by a freeze-drying method to remove the moisture, thereby obtaining a resin solid from which the surfactant and water were removed. 95 parts by mass of tetrahydrofuran was added to 5 parts by mass of the resin solid to obtain a suspension in which the resin solid was swollen and dissolved. The suspension was separated into a supernatant and a precipitate by a centrifugal separator. The supernatant contains a soluble component of the (meth)acrylic resin dissolved in tetrahydrofuran, and the precipitate contains an insoluble component of the (meth)acrylic resin that is not dissolved in tetrahydrofuran.

The dry weight of the precipitate was measured, and the gel fraction was calculated according to the following formula. The calculation results are listed in the columns of “gel fraction” in FIG. 2.

Formula: (dry mass of precipitate)/(mass of resin solid) × 100

2.3. Weight-average molecular weight of soluble component

The weight-average molecular weight of the soluble component of (meth)acrylic resin dissolved in tetrahydrofuran in terms of styrene in the supernatant was measured using gel permeation chromatography (GPC) of L7100 system (manufactured by Hitachi, Ltd.). The measurement results are listed in the columns of "weight-average molecular weight of soluble component" in FIG. 2.

### 3. Evaluation results

3.1. Mechanical strength

A transport member of a digital textile printing machine (product name: ML-8000, manufactured by Seiko Epson Corporation) having a surface which is an endless belt made of a urethane material was coated with the aqueous adhesive compositions of each example using a blade jig for ML-8000 and dried, thereby forming an adhesive layer having a film thickness of 50 μm on the transport member.

The adhesive layer obtained as described above was washed with a water washing brush provided in a digital textile printing machine (product name: ML-8000). The state of the adhesive layer when the fabric was transported by 5000 m and the fabric was transported by 10000 m was observed visually and evaluated according to the following criteria.

### Evaluation criteria

A: No scratch or peeling is observed even when the fabric is transported by 10000 m.

B: No scratch or peeling is observed when the fabric is transported by 5000 m, but slight scratch is observed when the fabric is transported by 10000 m.

C: Slight scratches are observed when the fabric is transported by 5000 m and 10000 m.

D: Deep scratches and peeling of the film are observed in several places when the fabric is transported by 10000 m.

E: Deep scratches and peeling of the film are observed in multiple places when the fabric is transported by 10000 m.

3.2. Durability

An adhesive layer was formed at the transport member using the same method as the method used for evaluating the mechanical strength. A digital textile printing machine (ML-8000) including a transport belt provided with the adhesive layer was continuously operated for 8 hours, and the state of the adhesive layer was visually observed and evaluated according to the following criteria. It can be said that the adhesive force decreases and the water resistance is inferior as the degree of whitening increases.

### Evaluation criteria

A: Occurrence of whitening is not observed, and the adhesive layer is transparent.

B: Slight occurrence of whitening is observed.

C: The adhesive layer is significantly whitened.

3.3. Adhesiveness

An adhesive layer was formed at the transport member using the same method as the method used for evaluating the mechanical strength. Next, a long fabric wound in a roll shape was unwound from an unwinding device, a tension was applied to the unwound fabric by a tensioner, and the fabric was transported in a state where the fabric was pressed onto the adhesive layer of the transport belt provided with the adhesive layer. As the fabric, a British-made see-through organza fabric that is difficult to stick and weak in pulling, and a 100% cotton fabric that is easy to stick were used. The evaluation was performed according to the following criteria. The expression “cannot be transported" includes an aspect in which the fabric cannot be transported at all because the fabric is not attached to the adhesive layer, and an aspect in which the fabric cannot be transported as intended because the fabric is shifted on the transport belt during the transport even though the fabric is attached to the adhesive layer.

### Evaluation criteria

A: Both the organza fabric and the cotton fabric can be transported.

B: Although the cotton fabric can be transported, the organza fabric cannot be transported.

C: Both the cotton fabric and the organza fabric cannot be transported.

3.4. Peelability

An adhesive layer was formed at the transport member using the same method as the method used for evaluating the mechanical strength. The transport belt on which the adhesive layer was formed closely adhered to the fabric by applying a pressure of 7.5 kPa for 1 second in a state where the fabric was placed on the adhesive layer. As the fabric, a British-made see-through organza fabric that is difficult to stick and weak in pulling, and a 100% cotton fabric that is easy to stick were used. After the close adhesion, the fabric was pulled up in the normal direction (90° direction) of the adhesive layer at a speed of 4 m/min (low speed) and a speed of 8 m/min (high speed) to attempt to peel off from the adhesive layer, and the evaluation was performed according to the following criteria.

### Evaluation criteria

A: Both the organza fabric and the cotton fabric can be peeled off at a high speed and a low speed without adhesion of the adhesive layer.

B: At least one of the organza fabric and the cotton fabric cannot be peeled off at a high speed without adhesion of the adhesive layer, but both the organza fabric and the cotton fabric can be peeled off at a low speed without adhesion of the adhesive layer.

C: When peeling is performed at a low speed, the adhesive layer adheres to at least one of the fabrics, or the fabric is irreversibly stretched.

3.5. Preservative property

1 g of the aqueous adhesive composition of each example was cultured in an agar medium at 30°C for 4 weeks, and an increase of bacteria and mold was observed and evaluated according to the following criteria. The number of bacteria and mold was counted automatically by capturing an image using a computer.

### Evaluation criteria

A: The number of bacteria and mold is 100 or less.

B: The number of bacteria and mold is 101 to 1000.

C: The number of bacteria and mold is 1001 or greater.

What is claimed is:

1. An aqueous adhesive composition for forming an adhesive layer on a surface of a transport member of an ink jet textile printing apparatus, which transports a fabric, the aqueous adhesive composition comprising:
water; and
a (meth)acrylic resin, wherein
the (meth)acrylic resin has a glass transition temperature of −40°C to −10°C, and
when 5 parts by mass of a dried substance obtained by drying the aqueous adhesive composition and removing the water is immersed in 95 parts by mass of tetrahydrofuran and stands at 25°C for 24 hours, a mass of an insoluble component of the (meth)acrylic resin that is not dissolved in the tetrahydrofuran is 1% to 10% by mass with respect to a total amount of the dried substance.

2. The aqueous adhesive composition according to claim 1, wherein
when 5 parts by mass of the (meth)acrylic resin and 95 parts by mass of the tetrahydrofuran are mixed at 25°C and stand for 24 hours, a soluble component of the (meth)acrylic resin dissolved in the tetrahydrofuran has a weight-average molecular weight of 50 × 10⁴ Da to 200 × 10⁴ Da.

3. The aqueous adhesive composition according to claim 1, wherein
the (meth)acrylic resin has a constitutional unit derived from a polyfunctional (meth)acrylate.

4. The aqueous adhesive composition according to claim 3, wherein
a content of the constitutional unit derived from a polyfunctional (meth)acrylate is greater than 0% by mass and 1% by mass or less with respect to a total amount of the (meth)acrylic resin.

5. The aqueous adhesive composition according to claim 1, further comprising:
0-00.001% by mass to 0.100% by mass of a preservative with respect to a total amount of the (meth)acrylic resin.

6. A transport belt of an ink jet textile printing apparatus, which transports a fabric, the transport belt comprising:
an adhesive layer containing the aqueous adhesive composition according to claim 1 on a surface of the transport belt, which is in contact with the fabric.

7. An ink jet textile printing apparatus comprising:
the transport belt according to claim 6; and
an ink jet head having a nozzle that ejects an ink to the fabric transported by the transport belt.
